(19) United States
(12) Patent Application Publication
(10) Pub. No.: US 2021/0146933 A1
(43) Pub. Date: May 20, 2021

(54) METHOD AND SYSTEM FOR MONITORING AND EVALUATING A PERFORMANCE OF A DRIVER OF A VEHICLE

(71) Applicant: Siemens Mobility, Inc., New York, NY (US)

(72) Inventors: Dennis Klingebiel, Atlanta, GA (US); Christopher Maynard, Roseville, CA (US); Thomas Süß, Berlin (DE)

(21) Appl. No.: 16/622,320

(22) PCT Filed: Apr. 23, 2018
(86) PCT No.: PCT/US2018/028786

§ 371 Date: Dec. 13, 2019

Related U.S. Application Data
(60) Provisional application No. 62/531,044, filed on Jul. 11, 2017.

(51) Int. Cl. B60W 40/09; G07C 5/08; G06Q 10/06; G06Q 30/00; G06Q 50/26; G06Q 50/30

(52) U.S. Cl. CPC B60W 40/09; G07C 5/0841; G06Q 10/06398; G06Q 30/018; G06Q 50/26; B60W 2040/0809; B60W 2555/20; B60W 2540/30; B60W 2540/22; B60W 2520/10; G06Q 50/30

(57) ABSTRACT

A method (200) for monitoring and evaluating performance of a driver (180) of a vehicle (160) through operation of a processor (310) includes recording (210) data by a vehicle (160), correlating (220) the data (170) to a driver (180) of the vehicle (160), and evaluating (230) a performance of the driver (180) based on the data (170), wherein the performance of the driver (180) is evaluated in a plurality of categories (115). Further, a driver rating system (100) and computer system (300) performing a method for monitoring and evaluating performance of a driver (180) of a vehicle (160) are disclosed.

### CROSS REFERENCE TO RELATED APPLICATIONS

This application claims benefit of U.S. provisional application No. 62/531,044 filed 11 Jul. 2017 in the United States Patent and Trademark Office, the content of which is herein incorporated by reference in its entirety.

### BACKGROUND

### 1. Field

Aspects of the present disclosure relate to a method and a system for monitoring and evaluating a performance of a driver of a vehicle. The method and system can be utilized in connection with many different types of vehicles. A vehicle as used herein is a motorized or non-motorized vehicle and can be for example a railed vehicle, a motor vehicle, a watercraft, an aircraft or a spacecraft.

### 2. Description of the Related Art

Today's transportation services are in huge competition with each other. Passengers have a choice among different service providers, transportation modes, vehicles, routings, ride times, as well as service standards. Most transportation providers aim to increase perception of their service quality to compete with other providers. Transportation providers also aim to optimize their service on a specific route with respect to costs (e.g. reduction of fuel), safety, emissions, on-time performance and availability among others. But there is no system available today that uses objective criteria to measure an impact of a driver's utilization of a vehicle with respect to quality of a transportation service.

### SUMMARY

A first aspect of the present disclosure provides a method for monitoring and evaluating performance of a driver of a vehicle, through operation of at least one processor, comprising recording data by a vehicle, correlating the data to a driver of the vehicle, and evaluating a performance of the driver based on the data, wherein the performance of the driver is evaluated in a plurality of categories.

A second aspect of the present disclosure provides a system for monitoring and evaluating performance of a driver of a vehicle comprising a vehicle comprising a plurality of sensing devices, a driver rating application comprising instructions executable by at least one processor to perform a method comprising recording data by a vehicle, correlating the data to a driver of the vehicle, and evaluating a performance of the driver based on the data, wherein the performance of the driver is evaluated in a plurality of categories.

A third aspect of the present disclosures provides a computer system comprising at least one processor; and an application comprising instructions executable by the at least processor to perform a method for monitoring and evaluating performance of a driver of a vehicle.

### BRIEF DESCRIPTION OF THE DRAWINGS

FIG. 1 illustrates a graphical representation of a system for monitoring and evaluating driver performance of a vehicle in accordance with an exemplary embodiment of the present disclosure.

FIG. 2 illustrates a flow chart of a method for monitoring and evaluating driver performance in accordance with an exemplary embodiment of the present disclosure.

FIG. 3 illustrates a block diagram of an example of a computer system capable of implementing the method and system according to embodiments of the present disclosure.

### DETAILED DESCRIPTION

To facilitate an understanding of embodiments, principles, and features of the present disclosure, they are explained hereinafter with reference to implementation in illustrative embodiments. In particular, they are described in the context of being a method and a system for monitoring and evaluating a driver performance of a vehicle. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

As noted before, many different transportation services are available today and passengers have the choice among different service providers, transportation modes, vehicles, routings, ride times, as well as service standards. Most transportation providers aim to increase perception of their service quality to compete with other providers.

An approach to measure a quality of a transportation service is to use both subjective criteria and objective criteria. Subjective criteria can be used to measure customer satisfaction of transportation services. For example, railroad operators, airline operators and car ride sharing providers assess a service quality by measuring customer satisfaction with passenger surveys. Car ride sharing providers may ask each rider about their subjective perception of the ride quality as soon as a trip has been completed. Since the passenger has a direct relation to the driver, customer satisfaction includes a rating of the driver. The rider rates a perceived performance of the ride including the perception of driver behavior (friendliness, wellbeing, on time performance, routing perception, etc.) as well satisfaction with the vehicle used to provide the service (e.g. cleanliness, color, trunk space, vehicle make, etc.), as well as the service itself (e.g. on time performance).

Objective criteria can be used to measure service quality, as defined for example by a set of key performance indicators, with respect to a vehicle model, individual vehicle, transportation mode, service provider etc. Examples for objective criteria include on time performance of a service that a railroad or airline operator provides on a specific route, emissions and fuel consumption for a specific vehicle model, frequency of schedule or transportation capacity, costs of the transportation service from point A to point B during a specific period or route, number of sold tickets for a transportation service from point A to point B, etc.

The present disclosure describes an approach for objectively measuring and evaluating an impact of a driver's utilization of a vehicle on a transportation service, because a driver has a large impact on the transportation service quality by operating the vehicle. The disclosed system and method focus on objective criteria, such as for example measurements and data, for evaluating a performance of the driver of the vehicle with respect to transportation service quality. Objective criteria as used herein essentially include conditions and characteristics that can be measured, monitored and/or evaluated by data and datasets that are collected and recorded, for example while the vehicle is operated by the driver. For example, a number of stop-and-go events (periodically enforced stops, for example caused by heavy traffic or traffic signals) of an individual car has an impact on a passenger's comfort, top speed has an impact on the passenger's safety and emissions of the vehicle, the amount of deceleration of a train or car has an impact on the received passenger comfort, and the duration of a vehicle door opened during a hot summer has an impact on energy consumption and therefore emissions of a vehicle as well as the passenger comfort since an inside temperature of the vehicle increases as long as the door is open.

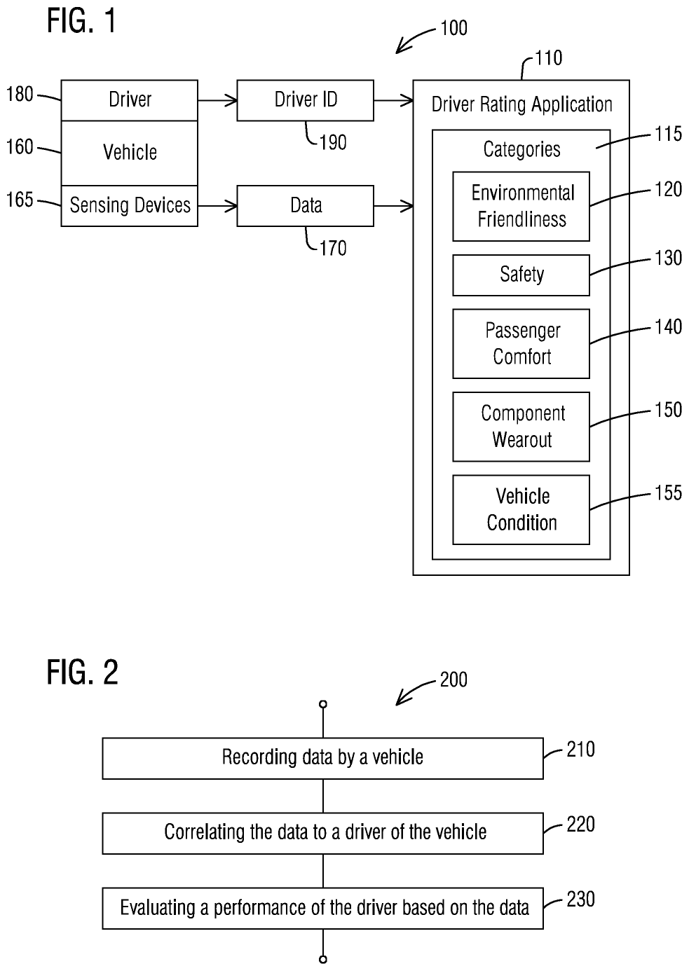

FIG. 1 illustrates a graphical representation of a system 100 for monitoring and evaluating a performance of a driver 180 of a vehicle 160 in accordance with an exemplary embodiment of the present disclosure. The system 100 is herein also referred to as “driver rating system” 100.

The vehicle 160 can be a motorized or non-motorized vehicle such as for example a railway vehicle, a motor vehicle including cars, coaches and busses, a watercraft, an aircraft, a spacecraft etc. The embodiments disclosed herein are primarily described in connection with railway vehicles, such as for example streetcars, light rail vehicles, automatic (airport) shuttles, metros, commuter trains, EMUs (Electric Multiple Units), DMUs (Diesel Multiple Unit), and high-speed trains etc. The vehicle 160 is operated by driver 180. Driver 180 can be for example a train operator, car driver, aircraft pilot etc., depending on the type of vehicle 160.

The vehicle 160 comprises multiple sensing devices 165 such as for example vehicle speed sensor, wheel speed sensor, torque sensor, tire pressure monitoring sensor, microphone, vehicle temperature sensor etc. Today's vehicles are produced with a plurality of (standard) sensing devices 165 which are utilized while the vehicle 160 is in operation, and the proposed system 100 utilizes those sensing devices 165 already installed in or at the vehicle 160.

The driver rating system 100 comprises a driver rating application 110. The driver rating application 110 can be utilized in connection with the many different types of vehicles 160 as noted above. The driver rating system 100, specifically the driver rating application 110, utilizes data 170 that are provided by the sensing devices 165. Collected data 170 are transmitted to the driver rating application 110. The driver rating application 110 is configured to receive, record and process the data 170. Further, the application 110 can be configured such that the data 170 are recorded, for example in a storage device within the vehicle 160.

Data 170 as used herein comprise data, datasets, values and/or measurements collected, recorded and/or stored by the vehicle 160, for example sensor data collected by the sensing devices 165. Examples for data 170 include vehicle acceleration, vehicle speed, vehicle motor temperature, vehicle motor torque, vehicle motor current, vehicle door opening durations, vehicle noise level, vehicle cabin temperature etc. Data 170 may also include measurements or parameters provided by external systems, e.g. sound/noise provided by speakers installed for example at various places around an airport runway or train stations. The vehicle 160 can be configured to record sound data provided by external systems.

With further reference to FIG. 1, the driver rating application 110 comprises instructions executable by at least one processor or controller. The driver rating application 110 is configured as software application. Specifically, the driver rating application 110 is configured to automatically evaluate a performance of the driver 180 based on the data 170 in multiple categories or criteria 115. The impact of the driver 180 is derived from the data 170 collected by the sensing devices 165 of the vehicle 160 while the driver 180 operates the vehicle 160.

In an exemplary embodiment of the present disclosure, the categories or criteria 115 used for evaluating the driver's performance comprise environmental friendliness 120, safety 130, passenger comfort 140, component wear out 150 and vehicle condition 155. It should be noted that other criteria, less or more criteria than those listed can be provided and evaluated.

In another exemplary embodiment, the driver 180 is identified (driver ID 190) and correlated to the data 170, for example e.g. by authentication at the system 100 or by using an operator schedule to correlate service timetable, driver, and vehicle identification. Thus, an evaluated performance can be directly related to the driver 180 of the vehicle 160.

As noted before, the driver rating application 110 measures, monitors and evaluates the driver's impact on environmental friendliness 120, safety 130, passenger comfort 140, component wear out 150 and vehicle condition 155.

The category 115 passenger comfort 140 relates to data 170 including measurements of observables (parameters) that quantify the quality of service provided to the transported passenger(s), for example while the driver 180 operates the vehicle 160. Data 170 relating to the passenger comfort 140 include vehicle speed, vehicle acceleration, vehicle deceleration, vehicle brake force, vehicle brake pressure, temperature in the vehicle, vehicle door opening durations, and vehicle horn usage, among others. These parameters are measured, quantified by calculating aggregated measures (e.g. count of acceleration cycles, average deceleration, median deceleration, number of stop-and-go events, average cabin temperature), and parameterized in terms of time, space, ambient conditions (e.g. outside temperature, outside humidity) the vehicle 160 is being operated in (e.g., per route, per route segment, time interval or period, time of day, day of week). Examples for evaluations for passenger comfort 140 include:
Average number and/or duration of deceleration events per route segment between point A and point B of route Z.
Maximum number of horn signals before station X.
Average vehicle cabin temperature during summer months.
Average vehicle cabin temperature during stations C and D for a certain passenger load.

Further granulation of passenger comfort 140 may include measurement of operator service quality with respect to passenger service related quantities (e.g., passenger miles travelled, number of stops per passenger, passenger minutes travelled, etc.), and examples include:
Number of high-deceleration events per passenger mile.
Average number of stop-and-go events per passenger mile.

Environmental friendliness 120 relates to the impact of the driver 180 on energy consumption of the vehicle 160. Examples of collected, recorded and processed/evaluated data 170 include for example number and/or duration of driving at maximum vehicle speed, average or median vehicle speed, number and/or duration of vehicle stop-and-go events, number and/or duration of vehicle deceleration events, burned fuel per route segment, consumed electrical energy per route segments, statistical measures of acceleration events (frequency, total number, average, maximum, medium acceleration etc.). Further examples of evaluations of environmental friendliness 120 may include:
Power consumption of auxiliary systems and consumer systems, e.g. heating-ventilation-air condition systems.
Duration of vehicle door openings. For example, when a streetcar (vehicle 160) at a station opens doors to board passengers, outside air heats or cools down air inside the streetcar, and humidity inside the streetcar may increase due to the door openings. The duration of door openings may also be calculated as a ratio of door opening duration(s) with respect to the number of passengers boarded at a specific station.

The category 115 safety 130 relates to the safety of the driver and passengers in the vehicle 160. Examples of collected and stored data 170 include speed limit violations, vehicle horn usage, vehicle door opening durations, number and/or duration of stop-and-go events (e.g. vehicle acceleration and deceleration events), number and/or duration of driving at vehicle maximum speed, and emergency brake events.

In another embodiment of the present disclosure, the driver rating system 100 is configured such that an impact of the driver's vehicle utilization on a vehicle lifecycle and a lifecycle of vehicle components is monitored, quantified and evaluated, which relates to component wear out 150 and vehicle condition 155.

The following is described with respect to component wear out 150 and/or vehicle condition 155 of railway vehicles, wherein component wear out 150 can be more specific than vehicle condition 155. For example, vehicle condition 155 may further cover other cases like linking drivers to vehicle accidents.

Today's railway vehicles record and process a huge amount of sensor readings. A focus of data recording systems in railway vehicles is to accelerate a service or maintenance engineer in finding the root cause of a (sub-) component failure within the technically complex mechanical or electrical system of both a railway vehicle or railway infrastructure element. Recently, continuous data recordings are used to alert an abnormal “behavior” of vehicle components and initiate corrective maintenance actions way before a component eventually fails. Predictive maintenance aims to optimize availability of assets by reducing asset outage time, as well as to reduce an impact on rail operations by unforeseen outages.

Railway data recording and processing systems are designed to optimize maintenance services around rail vehicles, as well as to provide additional insights about a vehicle and operator behavior in case of an accident or emergency case (event recorder). Furthermore, dedicated systems to optimize energy consumption of a vehicle exist. These systems perform a real-time evaluation of the energy consumption or delay of a rail vehicle and advise the operator to accelerate or decelerate the vehicle in a way that the energy consumption or delay is being optimized.

As an example, the driver's utilization of a railway vehicle, has an impact on wear out of wheels of the vehicle, e.g., number of stop-and-go events, number of roll-backs of a vehicle, amount of acceleration during rain. Furthermore, rail vehicles automatically sand railroad tracks to minimize (or avoid) wheel slipping, herein referred to as number and/or duration of sanding applied. An assessment of the driver's impact eventually improves the lifecycle of the wheels and reduces maintenance cycles (e.g. refilling the sand).

FIG. 2 illustrates a flow chart of a method 200 for monitoring and evaluating performance of a driver of a vehicle in accordance with an exemplary embodiment of the present disclosure. The method 200 utilizes the driver rating system 100 as described with reference to FIG. 1.

The method 200 is executed through operation of at least one processor or controller. In step 210, the data 170 are recorded by the vehicle 160. In step 220, the data 170 are correlated to the driver 180 of the vehicle 160, and in step 230, a performance of the driver 180 is evaluated based on the data 170 in a plurality of categories 115. Further details and elements of the method 200 are described with respect to the driver rating system 100 in connection with FIG. 1 and can be applied to the method 200. It should be noted that the method 200 can comprise additional steps, and/or steps 210, 220, 230 may be performed in a different order, for example step 230 may be performed before step 220, and/or steps may be repeated.

The disclosed system 100 and method 200 focus on objective criteria, such as for example measurements and data, for evaluating a performance of the driver 180 of the vehicle 160 with respect to transportation service quality since the driver 180 has a large impact on the transportation service quality by operating the vehicle 160. Use or application of the proposed driver rating system 100 and method 200 are described in the following paragraphs.

### Fully Automated and Autonomous Driving Systems

The proposed system 100 and method 200 can be used to evaluate and compare performance of automated driving systems (algorithms), e.g. communication-based train control, autonomous cars, or autonomous flight systems.

### Incentive Systems

The proposed driver rating system 100 and method 200 can be used to provide incentives for drivers that maximize the service quality with respect to a specific service criterion. Incentives might be given for the driver that
utilizes vehicles in a most environmentally friendly manner (e.g. lowest fuel consumption or minimal emissions),
utilizes vehicles in a most economically friendly manner (e.g. lowest utilization costs),
provides a highest service quality,
provides a highest on time performance,
provides a highest customer satisfaction with the transportation service.

### Recommendations to Driver to Improve Utilization of Vehicle

The proposed system 100 and method 200 may be used to provide recommendations how to improve each driver's utilization of the vehicle with respect to a specific service criterion. An example for a recommendation could be for example to drive slower on a specific route segment to reduce emissions, to close doors faster to reduce energy consumption of the air conditions, to propose a different route to avoid stop-and-go events and increase passenger comfort and reduce emissions.

### Training of Drivers Due to Objective Feedback

The driver rating system 100 and method 200 provide transparency with respect to utilization of vehicles to new as well as experienced drivers. Trainees transparently and objectively learn about the impact of their utilization of a vehicle with respect to their impact on the vehicle's lifecycle of the lifecycle of vehicle components, as well as the provided service quality.

New drivers can compare themselves to experienced drivers as well as to system recommendations to optimize vehicle utilization. Drivers can track their improvements with respect to individual learning categories. Training costs for new drivers are decreased. Training of new drivers is faster since improvement areas are identified faster, and improvement areas are more targeted. Less human supervision of training is needed.

### Route Planners for Individual Motor Vehicle Traffic

Individual motor vehicle traffic utilizes route planners to optimize their routing. Route planning systems recommend a fastest or eco-friendliest route for each driver. The route recommendation is being calculated on route profile, historical traffic data, as well as real-time traffic (e.g. congestions along the route). Users of route planners may increase accuracy of routing predictions by providing an average fuel consumption or travel speeds of the vehicle.

Future route planners may further improve predictions by including objective rating criteria as described in this disclosure. This would allow for an individual and more precise route planning. Route suggestions may be optimized to each driver's driving behavior, e.g. calculating the eco-friendliest route based on the individual, objectively measured driver behavior rather than assuming average emissions based on the vehicle type or comparable vehicles.

### Anonymous Processing of Personal Data

Personal data of a driver, e.g. driver name, can be replaced by one or more artificial identifiers, or pseudonyms. Another possibility is to assign one artificial identifier or pseudonym to a group of N drivers. Anonymity is guaranteed with a probability of 1/N in this case.

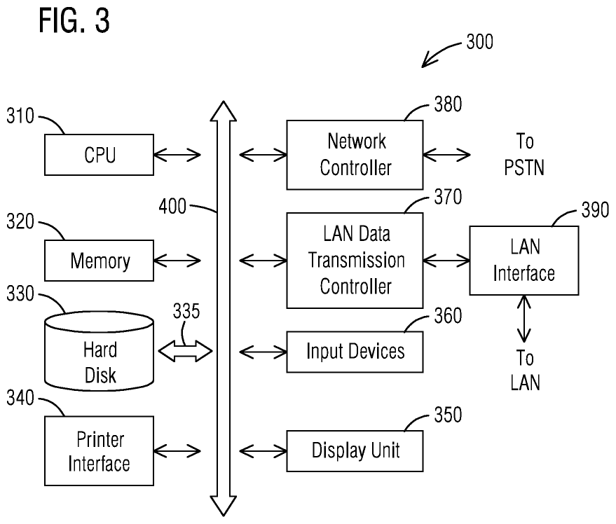

FIG. 3 shows an example of a computer system 300 which may implement a method 200 and system 100 of the present disclosure. The system 100 and method 200 of the present disclosure may be implemented in the form of a software application running on computer system 300, for example, a mainframe, personal computer (PC), handheld computer, server, etc. The software application may be stored on a recording media locally accessible by the computer system 300 and accessible via a hard wired or wireless connection to a network, for example, a local area network, or the Internet.

The computer system 300, referred to generally as system 300, may include, for example, a central processing unit (CPU) 310, random access memory (RAM) 320, a printer interface 340, a display unit 350, a local area network (LAN) data transmission controller 370, a LAN interface 390, a network controller 380, an internal bus 400, and one or more input devices 360, for example, a keyboard, mouse etc. As shown, the system 300 may be connected to a data storage device 330, for example a hard disk, via a link 335.

The computer system 300 executing the driver rating application 110 may be located within the vehicle 160, i.e. the vehicle 160 comprises computer system 300 for performing the method 200 of monitoring and evaluating performance of the driver 180 of the vehicle 160. In another embodiment, the driver rating application 110 and/or the computer system 300 may be located remotely to the vehicle 160. For example, the driver rating application 110 may be executed or performed on a central computer system 300, wherein the data 170 collected and recorded by individual vehicles 160 are transmitted to the central computer system 300. For example, data 170 of train operators recorded by train may be transmitted to a central computer system 300 located at a central train operator station.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

1.-26. (canceled)

27. A method for monitoring and evaluating performance of a driver of a vehicle, through operation of at least one processor, comprising:
recording data by a vehicle,
correlating the data to a driver of the vehicle, and
evaluating a performance of the driver based on the data, wherein the performance of the driver is evaluated in a plurality of categories.

28. The method of claim 27, wherein the data comprise measurements provided by sensing devices of the vehicle.

29. The method of claim 28, wherein the measurements are quantified and parameterized relative to time, space and ambient conditions of the vehicle when operated by the driver.

30. The method of claim 27, wherein the performance of the driver is evaluated in terms of environmental friendliness, and/or in terms of safety, and/or in terms of passenger comfort, and/or in terms of component wear out, and/or in terms of vehicle condition.

31. The method of claim 30, wherein the data for evaluating the performance of the driver in in terms of environmental friendliness comprise data and measurements of energy consumption of the vehicle.

32. The method of claim 31, wherein the data comprise data and measurements selected from number and/or duration of driving at vehicle maximum speed, vehicle average speed, number and/or duration of vehicle stop-and-go events, vehicle deceleration events, burned fuel of vehicle per route segment, consumed electrical energy of vehicle per route segment, statistical measurements of acceleration events, and a combination thereof.

33. The method of claim 30, wherein the data for evaluating the performance of the driver in terms of safety comprise data and measurements selected from vehicle speed limit violations, vehicle horn usage, vehicle door opening durations, number of vehicle deceleration and acceleration events, vehicle maximum speed, emergency brake events, and a combination thereof.

34. The method of claim 30, wherein the data for evaluating the performance of the driver in terms of passenger comfort comprise data and measurements selected from vehicle speed, number and/or duration of vehicle acceleration and deceleration events, vehicle brake force, vehicle brake pressure, vehicle indoor temperature, vehicle door opening durations, horn usage of the vehicle, and a combination thereof.

35. The method of claim 30, wherein the data for evaluating the performance of the driver in in terms of component wear out comprise data and measurements selected from number and/or duration of vehicle stop-and-go events, roll-backs of the vehicle, amount of acceleration, number and/or duration of sanding applied, and a combination thereof.

36. The method of claim 27, wherein correlating of the data to the driver comprises driver identification.

37. A system for monitoring and evaluating performance of a driver of a vehicle comprising:
a vehicle comprising a plurality of sensing devices collecting data comprising a plurality of measurements;
a driver rating application comprising instructions executable by at least one processor to perform a method comprising:
recording the data,
correlating the data to a driver of the vehicle, and
evaluating a performance of the driver based on the data, wherein the performance of the driver is evaluated in a plurality of categories.

38. The system of claim 37, wherein the vehicle is a railway vehicle, and wherein the driver rating application is executed on a computer system located in the vehicle.

39. The system of claim 37, wherein the performance of the driver is evaluated in terms of environmental friendliness, and/or safety, and/or passenger comfort, and/or component wear out, and/or vehicle condition.

40. The system of claim 39, wherein the data for evaluating the performance of the driver in terms of environmental friendliness comprise data and measurements of energy consumption of the vehicle.

41. The system of claim 40, wherein the data comprise data and measurements selected from number and/or duration of driving at vehicle maximum speed, vehicle average speed, number and/or duration of vehicle stop-and-go events, vehicle deceleration events, emergency brake events, burned fuel of vehicle per route segment, consumed electrical energy of vehicle per route segment and statistical measurements of acceleration events, and a combination thereof.

42. The system of claim 39, wherein the data for evaluating the performance of the driver in terms of safety comprise data and measurements selected from vehicle speed limit violations, vehicle horn usage, vehicle door opening durations, number and/or duration of vehicle deceleration and acceleration events, vehicle maximum speed, emergency brake events, and a combination thereof.

43. The system of claim 39, wherein the data for evaluating the performance of the driver in in terms of passenger comfort comprise data and measurements selected from vehicle speed, number and/or duration of vehicle acceleration and deceleration events, vehicle brake force, vehicle brake pressure, vehicle indoor temperature, vehicle door opening durations, horn usage of the vehicle, number of completed trips for public transportation, and a combination thereof.

44. The system of claim 39, wherein the data for evaluating the performance of the driver in in terms of component wear out and/or vehicle condition comprise data and measurements selected from number and/or duration of vehicle stop-and-go events, number of roll-backs of the vehicle), amount of acceleration, number and/or duration of sanding applied, and a combination thereof.

45. The system of claim 37, further comprising driver identification for correlating of the data to the driver.
